(19) United States
(12) Patent Application Publication
(10) Pub. No.: US 2019/0188910 A1
(43) Pub. Date: Jun. 20, 2019

(54) SYSTEMS AND METHODS FOR TELEPORTING A VIRTUAL POSITION OF A USER IN A VIRTUAL ENVIRONMENT TO A TELEPORTABLE POINT OF A VIRTUAL OBJECT

(71) Applicant: Tsunami VR, Inc., Del Mar, CA (US)

(72) Inventors: Anthony DUCA, Carlsbad, CA (US); Kyle PENDERGRASS, San Diego, CA (US)

(21) Appl. No.: 16/222,601

(22) Filed: Dec. 17, 2018

Related U.S. Application Data
(60) Provisional application No. 62/599,772, filed on Dec. 17, 2017.

(51) Int. Cl. G06T 19/00; G06F 3/01; G06T 19/20; G06T 15/20

(52) U.S. Cl. CPC G06T 19/003; G06F 3/013; G06T 2219/2016; G06T 15/20; G06T 19/006; G06T 19/20

(57) ABSTRACT

Teleporting a virtual position of a user in a virtual environment to a teleportable point of a virtual object shown in the virtual environment. Particular systems and methods identify a virtual object, determine teleportable points of the virtual object, detect intent by the user to relocate a virtual position of the user to a first teleportable point of the teleportable points, and relocate the virtual position of the user to the first teleportable point.

### CROSS REFERENCE TO RELATED APPLICATIONS

This application claims priority to U.S. Provisional Patent Application Ser. No. 62/599,772, filed Dec. 17, 2017, entitled “SYSTEMS AND METHODS FOR TELEPORTING A VIRTUAL POSITION OF A USER IN A VIRTUAL ENVIRONMENT TO A TELEPORTABLE POINT OF A VIRTUAL OBJECT,” the contents of which are hereby incorporated by reference in their entirety.

### BACKGROUND

### Technical Field

This disclosure relates to virtual reality (VR), augmented reality (AR), and hybrid reality technologies. More specifically, this disclosure relates to different approaches for teleporting a virtual position of a user in a virtual environment to a teleportable point of a virtual object.

### Related Art

Mixed reality (MR), sometimes referred to as hybrid reality, is the term commonly applied to the merging of real or physical world and virtual worlds to produce new environments and visualizations where physical and digital objects co-exist and interact. Mixed reality visualizations and environments can exists in the physical world, the virtual world, and can include a mix of reality, VR, and AR via immersive technology including interactive environments and interactive three-dimensional (3D) virtual objects. Users of MR visualizations and environments can move around the MR visualizations and interact with virtual objects within the virtual environment.

Interactive 3D virtual objects can be complex and contain large amounts of information that describe different features of the virtual objects, including the geometry, appearance, scenery, and animation of the virtual objects. Particular features of a virtual object may include shape, surface geometry, color, texture, material type, light sources, cameras, peripheral objects, animation, physical properties, and kinematics.

Interactive 3D virtual objects have properties such that a user can manipulate the object's color, shape, size, texture, material type, componentry, animation and behavior as interaction with the object occur.

### SUMMARY

An aspect of the disclosure provides a method for operating a virtual environment. The method can include identifying, at one or more processors, a virtual object within the virtual environment based on user action at a user device and a virtual position of a user associated with the user action within the virtual environment. The method can include determining, by the one or more processors, teleportable points of the virtual object. The method can include detecting intent by the user to relocate a virtual position of the user to a first teleportable point of the teleportable points, based on user action related to the virtual position of the user in the virtual environment. The method can include relocating the virtual position of the user to the first teleportable point of the virtual object.

Another aspect of the disclosure provides a non-transitory computer-readable medium comprising instructions for operating a virtual environment. When executed by one or more processors, the instructions cause the one or more processors to identify the virtual object within the virtual environment based on user action at a user device and a virtual position of a user associated with the user action within the virtual environment. The instructions further cause the one or more processors to determine teleportable points of the virtual object. The instructions further cause the one or more processors to detect intent by the user to relocate a virtual position of the user to a first teleportable point of the teleportable points, based on user action related to the virtual position of the user in the virtual environment. The instructions further cause the one or more processors to relocate the virtual position of the user to the first teleportable point of the virtual object.

Another aspect of the disclosure provides a non-transitory computer-readable medium comprising instructions for operating a virtual environment. When executed by one or more processors, the instructions cause the one or more processors to identify the virtual object within the virtual environment based on user action carrying or wearing an AR, MR or VR enabled user device and a virtual position of a user associated with the user action within the virtual environment. The instructions further cause the one or more processors to determine teleportable points of the virtual object. The instructions further cause the one or more processors to detect intent by the user to move a virtual position of the user in the direction of a first teleportable point of the teleportable points, based on user's movement while carrying or wearing an AR, MR or VR enabled user device in the physical world.

Other features and benefits will be apparent to one of ordinary skill with a review of the following description.

### BRIEF DESCRIPTION OF THE DRAWINGS

The details of embodiments of the present disclosure, both as to their structure and operation, can be gleaned in part by study of the accompanying drawings, in which like reference numerals refer to like parts, and in which:

FIG. 1A is a functional block diagram of system for creating computer-generated virtual environments and providing the virtual environments as an immersive experience for VR, AR and/or MR users;

FIG. 1B is a functional block diagram of user device for use with the system of FIG. 1;

FIG. 2 is a flowchart of an embodiment of a method for teleporting a virtual position of a user in a virtual environment to a teleportable point of a virtual object shown in the virtual environment;

FIG. 3A is a flowchart of an embodiment of a method for determining teleportable points of the virtual object executable by the system of FIG. 1A and FIG. 1B;

FIG. 3B is a flowchart of another embodiment of a method for determining teleportable points of the virtual object executable by the system of FIG. 1A and FIG. 1B;

FIG. 3C is a flowchart of another embodiment of a method for determining teleportable points of the virtual object executable by the system of FIG. 1A and FIG. 1B;

FIG. 3D is a flowchart of another embodiment of a method for determining teleportable points of the virtual object executable by the system of FIG. 1A and FIG. 1B;

FIG. 3E is a flowchart of another embodiment of a method for determining teleportable points of the virtual object executable by the system of FIG. 1A and FIG. 1B;

FIG. 4 is a flowchart of an embodiment of a method for detecting intent by the user to relocate a virtual position of the user to a first teleportable point; and

FIG. 5 is a flowchart of an embodiment of a method for teleporting a virtual position of a user in a virtual environment to a location in the virtual environment that is not on a surface in the virtual environment.

### DETAILED DESCRIPTION

VR devices allow a user in the physical world to interact with a virtual environment. The virtual environment may be made up entirely or a three dimensional, virtual representation of a physical environment. User devices, head mounted displays, tools, controllers, and various other components can allow a user to interact with virtual objects and move within the virtual environment. The user operating or wearing the VR equipment (e.g., the VR user device) may be tethered (e.g., by wires or other components) or otherwise limited in an ability to move within the physical environment to move an associated avatar in the virtual environment. The equipment used to simulate the VR environment limits the user's movement by tethering the wearable user device to a computer via a cable or confining the user to an area in which VR componentry can detect and track user movement. However, virtual environments may exceed the confines of the area required by the VR componentry to track the user's movements. Teleportation or the ability to teleport provides the ability to move (a viewpoint, an avatar, a perspective) large distances within the virtual environment that exceed the associated user's ability to move within the limitations imposed by the VR componentry. AR or MR users are not limited by the same restrictions as the VR componentry because the AR and MR technology uses the sensors and other technologies that exists in the AR enabled user device to track their movement and location within the physical environment.

In addition to limitations imposed on the componentry of the VR system, the user is limited in movement by defined areas or surfaces on which the user is allowed to teleport. The computer representation of a virtual environment includes well-defined areas upon which the user is allowed to move. In addition, virtual objects within the virtual environment do not include similarly defined areas on which the user can move, necessarily limiting the users interaction with the virtual objects. Surfaces of virtual objects can be on or within the virtual objects.

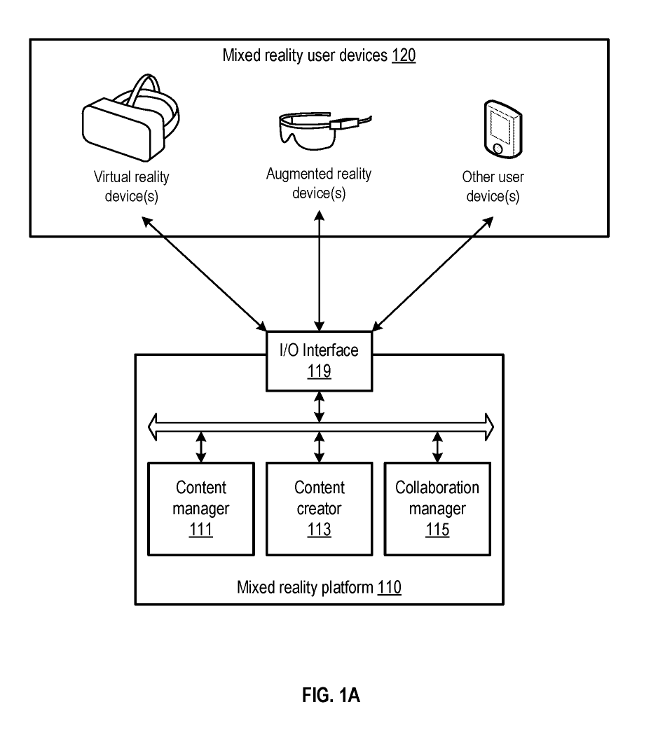

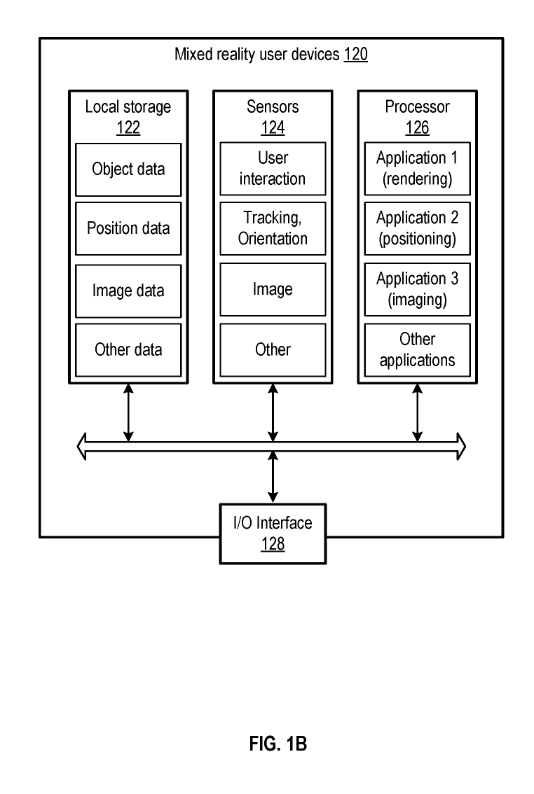

FIG. 1A is a functional block diagram of system for creating computer-generated virtual environments and providing the virtual environments as an immersive experience for VR, AR and/or MR users. The system depicted in FIG. 1A includes an embodiment of a system for teleporting a virtual position of a user in a virtual environment to a teleportable point of a virtual object. The system includes a mixed reality platform 110 that is communicatively coupled to any number of mixed reality user devices 120 such that data can be transferred between them as required for implementing the functionality described in this disclosure. General functional details about the platform 110 and the user devices 120 are discussed below before particular functions involving the platform 110 and the user devices 120 are discussed.

As shown in FIG. 1A, the platform 110 includes different architectural features, including a content manager 111, a content creator 113, a collaboration manager 115, and an input/output (I/O) interface 119. The content creator 113 creates a virtual environment and visual representations of things (e.g., virtual objects and avatars) that can be displayed in a virtual environment depending on a user's point of view. Raw data may be received from any source, and then converted to virtual representations of that data. Different versions of a virtual object may also be created and modified using the content creator 113. The content manager 111 stores content created by the content creator 113, stores rules associated with the content, and also stores user information (e.g., permissions, device type, or other information). The collaboration manager 115 provides portions of a virtual environment and virtual objects to each of the user devices 120 based on conditions, rules, poses (e.g., positions and orientations) of users in a virtual environment, interactions of users with virtual objects, and other information. The I/O interface 119 provides secure transmissions between the platform 110 and each of the user devices 120.

FIG. 1B is a functional block diagram of user device for use with the system of FIG. 1. Each of the user devices 120 include different architectural features and components, and may include the features shown in FIG. 1B, including a local storage 122, sensors 124, processor(s) 126, and an input/output interface 128. The local storage 122 stores content received from the platform 110, and information collected by the sensors 124. The processor 126 runs different applications needed to display any virtual object or virtual environment to a user operating a user device. Such applications include rendering, tracking, positioning, 2D and 3D imaging, and other functions. The I/O interface 128 from each user device 120 manages transmissions between that user device 120 and the platform 110. The sensors 124 may include inertial sensors that sense movement and orientation (e.g., gyros, accelerometers and others), optical sensors used to track movement and orientation, location sensors that determine position in a physical environment, depth sensors, cameras or other optical sensors that capture images of the physical environment or user gestures, audio sensors that capture sound, and/or other known sensor(s). Depending on implementation, the components shown in the user devices 120 can be distributed across different devices (e.g., a worn or held peripheral separate from a processor running a client application that is communicatively coupled to the peripheral). Examples of such peripherals include head-mounted displays, AR glasses, and other peripherals.

Some of the sensors 124 (e.g., inertial, optical, and location sensors) are used to track the pose (e.g., position and orientation) of a user in virtual environments and physical environments. Tracking of user position and orientation (e.g., of a user head or eyes) is commonly used to determine view areas, and the view area is used to determine what virtual objects to render using the processor 126 for presentation to the user on a display of a user device. Tracking the positions and orientations of the user or any user input device (e.g., a handheld device) may also be used to determine interactions with virtual objects. Tracking of a user position and movement can also be achieved by using sensors to determine the direction, speed and distance a user has moved physically and converting that to movement within the virtual space. This is well known method in AR for tracking a user's position in a physical space. In some embodiments, an interaction with a virtual object includes a modification (e.g., change color or other) to the virtual object that is permitted after a tracked position of the user or user input device intersects with a point of the virtual object in a geospatial map of a virtual environment, and after a user-initiated command is provided to make the desired modification. Positions in a physical environment may be tracked in different ways, including positioning using Global Navigation Satellite Systems (GNSS), Bluetooth, WiFi, an altimeter, geospatial tracking, or any other known way to estimate the position of a thing (e.g., a user) in a physical environment.

Some of the sensors 124 (e.g., cameras and other optical sensors of AR devices) may also be used to capture information about a physical environment, which is used to generate virtual representations of that information, or to generate geospatial maps of the physical environment that can be used to determine where and how to present virtual objects among physical objects of the physical environment. Such virtual representations and geospatial maps may be created using any known approach. In one approach, many two-dimensional images are captured by a camera of an AR device, those two-dimensional images are used to identify three-dimensional points in the physical environment, and the three-dimensional points are used to determine relative positions, relative spacing and structural characteristics (e.g., surfaces and depths) of physical objects in the physical environment. Other optical sensors may be used in addition to a camera (e.g., a depth sensor). Textures, colors and other features of physical objects or physical environments can be determined by analysis of individual images. Regardless of the method of capturing the characteristics of the physical space, the resulting virtual representations of physical space can be used in VR as teleportable virtual objects.

Examples of the user devices 120 include VR, AR, MR and general computing devices with displays, including head-mounted displays, sensor-packed wearable devices with a display (e.g., glasses), mobile phones, tablets, desktop computers, laptop computers, or other computing devices that are suitable for carrying out the functionality described in this disclosure.

The methods or processes outlined and described herein and particularly those that follow below, can be performed by one or more processors of the platform 110 either alone or in connection or cooperation with the user device(s) 120. The processes can also be performed using distributed or cloud-based computing.

### Teleporting a Virtual Position of a User in a Virtual Environment to a Teleportable Point of a Virtual Object

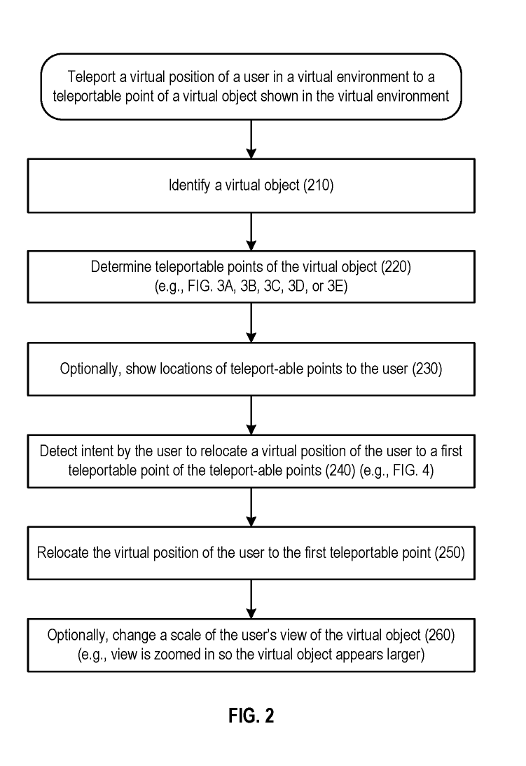

FIG. 2 is a flowchart of an embodiment of a method for teleporting a virtual position of a user in a virtual environment to a teleportable point of a virtual object shown in the virtual environment. The method of FIG. 2 can be performed by the system of FIG. 1A and FIG. 1B A “teleportable” point, teleportable location, or other teleportable thing, is a point, location (in, around, or on an object), or other thing to which a virtual position of a user can move from another virtual position. This disclosure refers to relocation of a virtual position of the user via teleportation within the virtual environment. Thus, the methods or processes described herein may refer to the relocation of the virtual position (e.g., the avatar) of the user. The “relocation of the virtual position of the user” can include relocation of an avatar of the user within the virtual environment or a relocation or modification of a perspective or view point of the virtual environment experienced by the user (displayed on the user device 120).

Such relocation or teleportation can include moving an avatar or a user point of view from one place within the virtual environment to another place within the virtual environment, instantly. For example, a physical environment within which the user operates the user device 120 as a VR user device may not be scaled or even the same size as the virtual world simulated within it. Therefore, physical constraints experienced by the VR user in the physical world may confine or otherwise limit movement within the virtual environment. Accordingly, teleportation allows the VR user (or the associate avatar) to move from point to point within the virtual environment regardless of constraints of the surrounding physical environment.

In some other embodiments, a user and an associated AR or MR user device can translate freely within the physical environment. The AR- or MR-enabled user device 120 can thus display a view of the virtual environment displayed on the device, based on movement, position, and orientation of the associated user device 120. Accordingly, teleportation in this sense can further include movement of the AR/MR user device in the physical world that is translated to avatar (or user viewpoint) position and orientation within the associated virtual world. The methods disclosed herein include application for both repositioning of an avatar of a VR user within the virtual environment and translation or movement of the AR/MR user (in the physical world) as an avatar within the associated virtual environment. This not only allows the VR user/avatar to instantly teleport from one place to another, or onto or into a virtual object (e.g., a car), but also allow the avatar of the AR/MR user to enter the same object (e.g., the car) based on the user device movement in the physical world, providing the AR/MR user the perspective of the avatar moving (e.g., teleporting) through the virtual environment.

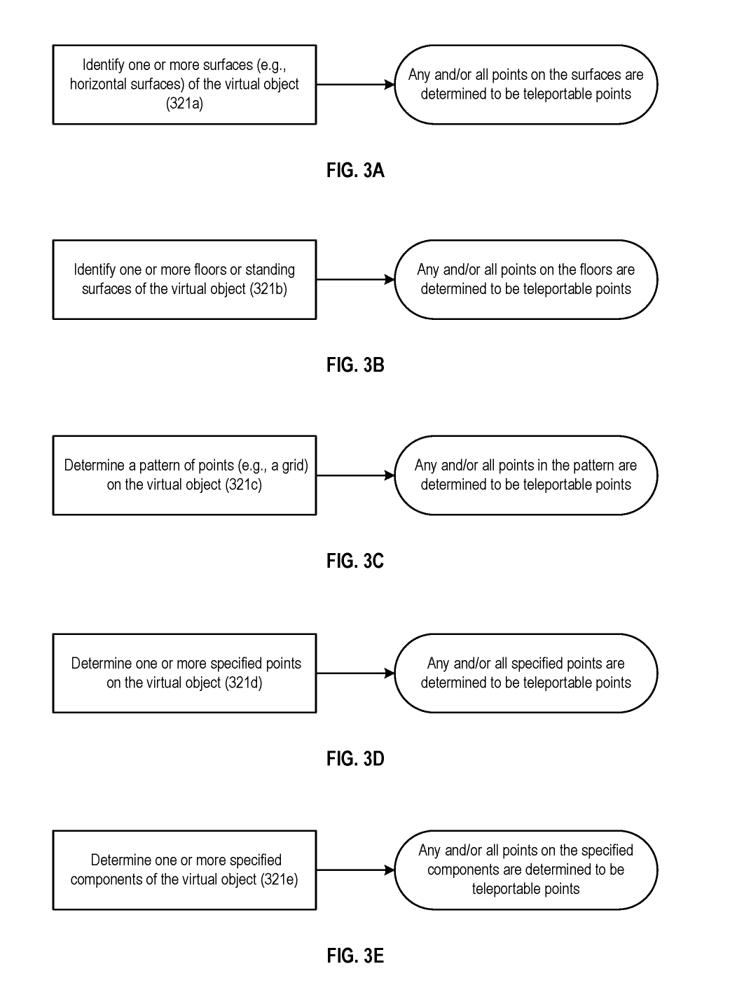

As shown in FIG. 2, a virtual object is identified (210), and teleportable points of the virtual object are determined (220). Examples of step 220 are provided in FIG. 3A, FIG. 3B, FIG. 3C, FIG. 3D, or FIG. 3E. By way of example, points may be locations of pixels, components, or other features of the virtual object. The teleportable points can represent locations to which the user view or avatar can be repositioned. The teleportable points can, for example, be identified with the import or creation of a given virtual object (e.g., a car having points on, in, and around it).

Optionally, locations of teleportable points are shown to the user (230) via the user device 120. This step may include sub-steps of (i) generating executable instructions that cause a user device operated by the user to display respective locations of one or more of the teleportable points to the user (e.g., as computer-generated images, highlighted parts of the virtual object, or another means to display), (ii) transmitting the executable instructions to the user device, and (iii) executing the instructions at the user device to cause the user device to display the respective locations of the one or more teleportable points. A VR-enabled user device 120 can display such points to the user within the virtual world. The user can use tools or controllers to select the points as described herein. On an AR- or MR-enable device, the points may also be displayed, but in two dimensions on the associated display.

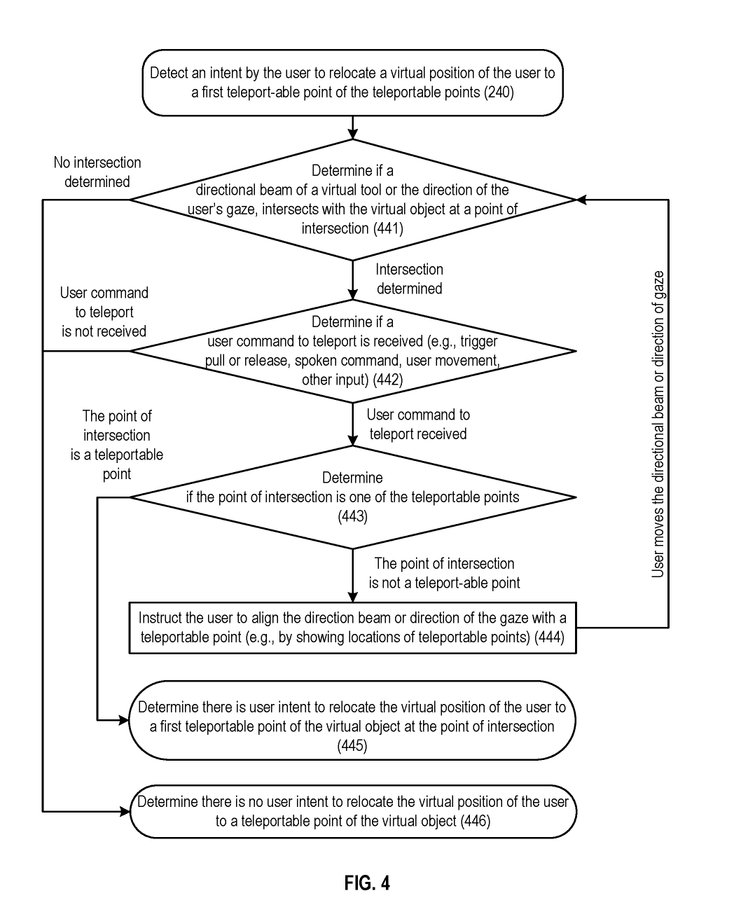

Intent by the user to relocate a virtual position of the user to a first teleportable point of the teleportable points is detected (240). An example of step 240 is provided in FIG. 4. As described below in connection with FIG. 4, intent can be determined by the use of various tools or controllers by a VR user. In addition, the system can further use the position or translation of an AR- or MR-enabled user device (in the physical world) to indicate intent by the user to relocate. This can be done, for example, using motion of the user device 120 (e.g., a motion vector), toward one or more of the identified (210) od displayed (22) teleportable points.

After detecting the intent by the user to relocate the virtual position of the user to the first teleportable point, the virtual position of the user is relocated to the first teleportable point (250). In some embodiments, the VR user (e.g., the avatar) can be instantly moved from one point to another in the virtual world. In embodiments implementing AR- or MR-enabled user devices 120, the movement or teleportation can be based at least in part on the movement, position, and orientation of the AR/MR user device 120 in the physical world.

Optionally, a scale of the user's view of the virtual object is changed (260). When step 260 is carried out in one embodiment, a determination is made as to whether the size of the virtual object is less than the size of the user's avatar, and if so, the user's view is zoomed in so viewable parts of the virtual object appear larger at the relocated virtual position.

### Determining Teleportable Points of the Virtual Object (220)

Each of FIG. 3A through FIG. 3E show various embodiments of processes for determining teleportable points of the virtual object during step 220 of FIG. 2.

FIG. 3A is a flowchart of an embodiment of a method for determining teleportable points of the virtual object executable by the system of FIG. 1A and FIG. 1B. As shown in FIG. 3A, one implementation of step 220 includes identifying one or more surfaces (e.g., horizontal surfaces) of the virtual object (321a), and then determining that any and/or all points on the identified surfaces are teleportable points. In one embodiment, a pattern of points (e.g., a grid of points) on any and/or all of the identified surfaces is identified, and each point in the pattern is determined to be a teleportable point. As used herein, the “surfaces” within the virtual environment having teleportable points may generally be substantially horizontal, in keeping with the simulation of real-world physics and gravitational forces as related to the user teleporting to such a surface, for example. However, surfaces may not be so limited and can include inclined, curved, or textured (e.g., not flat) surfaces of virtual objects.

FIG. 3B is a flowchart of another embodiment of a method for determining teleportable points of the virtual object executable by the system of FIG. 1A and FIG. 1B. As shown in FIG. 3B, another implementation of step 220 includes identifying one or more floors or standing surfaces of the virtual object (321b), and determining that any and/or all points on the floors are teleportable points. In one embodiment, a pattern of points (e.g., a grid of points) on any and/or all of the identified floors or standing surfaces is identified, and each point in the pattern is determined to be a teleportable point.

FIG. 3C is a flowchart of another embodiment of a method for determining teleportable points of the virtual object executable by the system of FIG. 1A and FIG. 1B. As shown in FIG. 3C, another implementation of step 220 includes determining a pattern of points (e.g., a grid of points) on the virtual object (321c), and determining that any and/or all points in the pattern are teleportable points.

FIG. 3D is a flowchart of another embodiment of a method for determining teleportable points of the virtual object executable by the system of FIG. 1A and FIG. 1B. As shown in FIG. 3D, another implementation of step 220 includes determining one or more specified points on the virtual object (321d), and determining that any and/or all specified points are teleportable points. In one embodiment, specified points include individual points or groups of points that were previously specified by a user (e.g., by selecting the points, or selecting components that include the points).

FIG. 3E is a flowchart of another embodiment of a method for determining teleportable points of the virtual object executable by the system of FIG. 1A and FIG. 1B. As shown in FIG. 3E, another implementation of step 220 includes determining one or more specified components of the virtual object (321e), and determining that any and/or all points on the specified components are teleportable points. In one embodiment, each specified component was previously specified by a user (e.g., by selecting the component via the user device 120). In another embodiment, each specified component is automatically identified based on an identifier of that component that designates the component's suitability as a teleportable point. Examples of identifiers include: “floor”, “level”, “platform”, “walkway”, or other terms that designate a type of feature on which a person (e.g., an avatar of a person within the virtual environment) could stand or at which the person could be located. Alternatively, a detectable characteristic of the component may be determined, where the characteristic designates the component as a floor, level, platform, walkway, or other thing on which a person could stand or at which the person could be located.

### Detecting Intent by the User to Relocate a Virtual Position of the User to a First Teleportable Point (240)

FIG. 4 is a flowchart of an embodiment of a method for detecting intent by the user to relocate a virtual position of the user to a first teleportable point. The method of FIG. 4 can be performed during step 240 of FIG. 2. As shown in FIG. 4, a determination is made as to whether a directional beam of a virtual tool, the direction of the user's gaze intersects with the virtual object at a point of intersection, or the user (e.g., avatar) physically moves to a teleportable point on the virtual object (441). Various known technologies may be used to generate a directional beam and determine its path in a virtual environment. Similarly, various known technologies may be used to determine a direction of a user's gaze into a virtual environment and determine its path in that virtual environment. An intersection is determined when the path of the directional beam or the path of the gaze direction meets part of the virtual object (e.g., a surface on the inside or the outside of the virtual object), and the point of intersection is the point where the path meets the part of the virtual object. Similarly, various known technologies can be used to determine the user's physical movement within the virtual space and when the user or the user's avatar physically moves to a teleportable point.

When the result of step 441 is a determination that there is no intersection, a determination is made that there is no user intent to relocate the virtual position of the user to a teleportable point of the virtual object.

When the result of step 441 is a determination that there is an intersection, a determination is made as to whether a user command to teleport is received (442). Examples of user commands to teleport include (i) a command created when the user depresses or releases a trigger or button on a user input device (e.g., a handheld tool), (ii) a command created when the user speaks a recognized word or phrase (“teleport”), (iii) an elapsed period of time (e.g., predetermined period of time), or (iv) another input. In some embodiments, the user command may be implicit and occur automatically. For example, the user's gaze may lie on the point or form an intersection for a predetermined period of time, or the act of physically moving the avatar to an intersection point and remaining in place for a predetermined period of time may be sufficient to constitute or trigger the command of step 442.

When the result of step 442 is a determination that a user command to teleport is not received, a determination is made that there is no user intent (446) to relocate the virtual position of the user to a teleportable point of the virtual object.

When the result of step 442 is a determination that a user command to teleport is received, a determination is made as to whether the point of intersection is one of the teleportable points (443).

When the result of step 443 is a determination that the point of intersection is a teleportable point, a determination is made (445) that there is user intent to relocate the virtual position of the user to a first teleportable point of the virtual object at the point of intersection.

When the result of step 443 is a determination that the point of intersection is not a teleportable point, an optional instruction is given to the user to align the directional beam or direction of the user's gaze with a teleportable point (444). In one embodiment, the instruction includes computer-generated images showing locations of teleportable points within the virtual environment.

If the optional instruction is given, the user moves the directional beam or direction of gaze, and the process returns to step 441.

Teleporting a Virtual Position of a User in a Virtual Environment to a Location in the Virtual Environment that is not on a Surface in the Virtual Environment

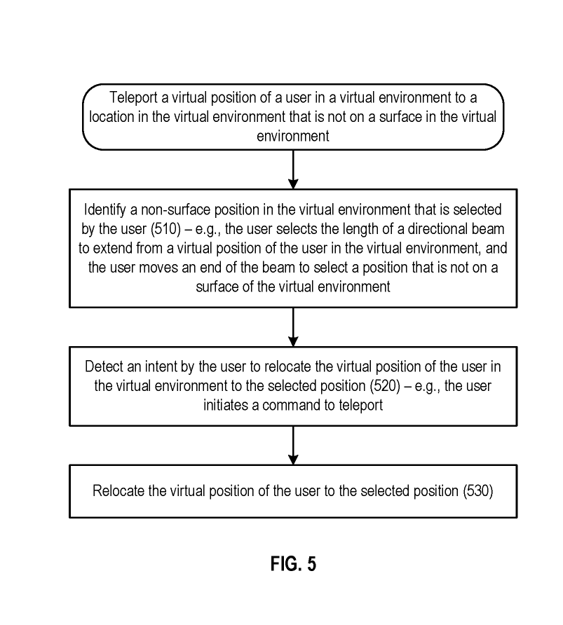

FIG. 5 is a flowchart of an embodiment of a method for teleporting a virtual position of a user in a virtual environment to a location in the virtual environment that is not on a surface in the virtual environment. FIG. 5 can be implemented to exclude only surfaces of the virtual environment, or to exclude surfaces of the virtual environment and virtual objects in the virtual environment, such that the location is in virtual air (e.g., floating above surfaces).

As shown in FIG. 5, a non-surface position in the virtual environment that is selected by the user (e.g., via the user device 120) is identified (510). By way of example, in one embodiment of step 510, the user selects the length of a directional beam to extend from a virtual position of the user in the virtual environment, and the user moves an end of the beam to select a position that is not on a surface of the virtual environment (e.g., a position in virtual air).

Intent by the user to relocate the virtual position of the user (e.g., the avatar of the user or the user point of view within the virtual environment) in the virtual environment to the selected position is detected (520). By way of example, in one embodiment of step 520, the user initiates a command to teleport to the selected position. Examples of commands to teleport include (i) a command created when the user depresses or releases a trigger or button on a user input device (e.g., a handheld tool), (ii) a command created when the user speaks a recognized word or phrase (“teleport”), or (iii) another input.

After detecting intent by the user to relocate the virtual position of the user in the virtual environment to the selected position, the virtual position of the user is relocated to the selected position (530).

### Other Aspects

Each method of this disclosure can be used with virtual reality (VR), augmented reality (AR), mixed reality (MR), and/or non-VR/AR/MR technologies (e.g., the platform 110 and the user devices 120). Virtual environments and virtual objects may be presented using VR technologies, AR technologies, MR technologies and/or non-VR/non-AR/non-MR technologies.

The accompanying claims and their equivalents are intended to cover such forms or modifications as would fall within the scope of the disclosure. For instance, the example apparatuses, methods, and systems disclosed herein may be applied to VR, AR, and MR technologies. The various components illustrated in the figures may be implemented as, for example, but not limited to, software and/or firmware on a processor or dedicated hardware. Also, the features and attributes of the specific example embodiments disclosed above may be combined in different ways to form additional embodiments, all of which fall within the scope of the disclosure.

Reference throughout this specification to “one embodiment” or “an embodiment” means that a particular feature, structure, or characteristic described in connection with the embodiment is included in at least one embodiment. Thus, appearances of the phrases “in one embodiment” or “in an embodiment” in various places throughout this specification are not necessarily all referring to the same embodiment. In addition, use of “in an embodiment” or similar phrasing is not intended to indicate a different or mutually exclusive embodiment, but to provide a description of the various manners of implementing the inventive concepts described herein. Furthermore, the particular features, structures, or characteristics of such embodiments may be combined in any suitable manner in one or more embodiments.

Methods of this disclosure may be implemented by hardware, firmware or software. One or more non-transitory machine-readable media embodying program instructions that, when executed by one or more machines, cause the one or more machines to perform or implement operations comprising the steps of any of the methods or operations described herein are contemplated. As used herein, machine-readable media includes all forms of machine-readable media (e.g. non-volatile or volatile storage media, removable or non-removable media, integrated circuit media, magnetic storage media, optical storage media, or any other storage media) that may be patented under the laws of the jurisdiction in which this application is filed, but does not include machine-readable media that cannot be patented under the laws of the jurisdiction in which this application is filed.

By way of example, machines may include one or more computing device(s), processor(s), controller(s), integrated circuit(s), chip(s), system(s) on a chip, server(s), programmable logic device(s), other circuitry, and/or other suitable means described herein (e.g., the platform 110, the user device 120) or otherwise known in the art. Systems that include one or more machines or the one or more non-transitory machine-readable media embodying program instructions that, when executed by the one or more machines, cause the one or more machines to perform or implement operations comprising the steps of any methods described herein are also contemplated.

Method steps described herein may be order independent, and can therefore be performed in an order different from that described. It is also noted that different method steps described herein can be combined to form any number of methods, as would be understood by one of skill in the art. It is further noted that any two or more steps described herein may be performed at the same time. Any method step or feature disclosed herein may be expressly restricted from a claim for various reasons like achieving reduced manufacturing costs, lower power consumption, and increased processing efficiency. Method steps can be performed at any of the system components shown in the figures.

Systems comprising one or more modules that perform, are operable to perform, or adapted to perform different method steps/stages disclosed herein are also contemplated, where the modules are implemented using one or more machines listed herein or other suitable hardware. When two things (e.g., modules or other features) are “coupled to” each other, those two things may be directly connected together, or separated by one or more intervening things. Where no lines and intervening things connect two particular things, coupling of those things is contemplated in at least one embodiment unless otherwise stated. Where an output of one thing and an input of another thing are coupled to each other, information sent from the output is received by the input even if the data passes through one or more intermediate things. Different communication pathways and protocols may be used to transmit information disclosed herein. Information like data, instructions, commands, signals, bits, symbols, and chips and the like may be represented by voltages, currents, electromagnetic waves, magnetic fields or particles, or optical fields or particles.

The words comprise, comprising, include, including and the like are to be construed in an inclusive sense (i.e., not limited to) as opposed to an exclusive sense (i.e., consisting only of). Words using the singular or plural number also include the plural or singular number, respectively. The word or and the word and, as used in the Detailed Description, cover any of the items and all of the items in a list. The words some, any and at least one refer to one or more. The term may is used herein to indicate an example, not a requirement—e.g., a thing that may perform an operation or may have a characteristic need not perform that operation or have that characteristic in each embodiment, but that thing performs that operation or has that characteristic in at least one embodiment.

What is claimed is:

1. A method for operating a virtual environment comprising:
identifying, at one or more processors, a virtual object within the virtual environment based on user action at a user device and a virtual position of a user associated with the user action within the virtual environment;
determining, by the one or more processors, teleportable points of the virtual object;
detecting intent by the user to relocate a virtual position of the user to a first teleportable point of the teleportable points, based on user action related to the virtual position of the user in the virtual environment;
relocating the virtual position of the user to the first teleportable point of the virtual object.

2. The method of claim 1, wherein determining teleportable points of the virtual object comprises:
identifying one or more surfaces of the virtual object, the one or more surfaces being on the inside or the outside of the virtual object; and
determining that any point on the one or more surfaces is one of the teleportable points.

3. The method of claim 2, wherein the one or more surfaces are one or more horizontal surfaces.

4. The method of claim 1, wherein determining teleportable points of the virtual object comprises:
identifying one or more floors or standing surfaces of the virtual object; and
determining that any point on the identified one or more floors or standing surfaces is one of the teleportable points.

5. The method of claim 1, wherein determining teleportable points of the virtual object comprises:
determining a pattern of points on the virtual object; and
determining that any point on the pattern of points is one of the teleportable points.

6. The method of claim 5, wherein the pattern of points is a grid of points.

7. The method of claim 1, wherein determining teleportable points of the virtual object comprises:
identifying one or more specified points on the virtual object; and
determining that the one or more specified points are the teleportable points.

8. The method of claim 7, wherein another user designated the one or more specified points before the one or more specified points are identified.

9. The method of claim 1, wherein determining teleportable points of the virtual object comprises:
identifying one or more specified components of the virtual object; and
determining that any point on the one or more specified components is one of the teleportable points.

10. The method of claim 9, wherein another user designates the one or more specified components before the one or more specified components are identified.

11. The method of claim 1, wherein detecting intent by the user to relocate a virtual position of the user to a first teleportable point comprises:
determining whether a directional beam of a virtual tool or a direction of a gaze of the user intersects with the virtual object at a point of intersection;
after determining that the directional beam or the direction of the gaze does not intersect with the virtual object, determining that there is no user intent to relocate the virtual position of the user to a teleportable point of the virtual object;
after determining that the directional beam or the direction of the gaze intersects with the virtual object, determining whether a user command to teleport is received;
after determining that no user command to teleport is received, determining that there is no user intent to relocate the virtual position of the user to a teleportable point of the virtual object;
after determining that the user command to teleport is received, determining whether the point of intersection is one of the teleportable points; and
after determining that the point of intersection is one of the teleportable points, determining that there is user intent to relocate the virtual position of the user to the first teleportable point of the virtual object at the point of intersection.

12. The method of claim 11, wherein detecting intent by the user to relocate a virtual position of the user to a first teleportable point further comprises:
after determining that the point of intersection is not one of the teleportable points, instructing the user to align the directional beam or the direction of the gaze so the directional beam or the direction of the gaze intersects one of the teleportable points.

13. The method of claim 1, wherein the method further comprises displaying, to the user, one or more locations of one or more teleportable points from the determined teleportable points.

14. The method of claim 1, wherein the method further comprises changing a scale of the virtual object to enlarge the appearance of the virtual object as viewed by the user at the first teleportable point.

15. The method of any of claim 1, further comprising using a virtual reality (VR) user device, an augmented reality (AR) user device, or a mixed reality (MR) user device to detect the intent by the user to relocate a virtual position of the user to the first teleportable point of the virtual object, and to display the virtual environment to the user.

16. A non-transitory computer-readable medium comprising instructions for operating a virtual environment, that when executed by one or more processors cause the one or more processors to:
identify the virtual object within the virtual environment based on user action at a user device and a virtual position of a user associated with the user action within the virtual environment;
determine teleportable points of the virtual object;
detect intent by the user to relocate a virtual position of the user to a first teleportable point of the teleportable points, based on user action related to the virtual position of the user in the virtual environment;
relocate the virtual position of the user to the first teleportable point of the virtual object.

17. The non-transitory computer-readable medium of claim 16, wherein the instructions further cause the one or more processors to:
identify one or more surfaces of the virtual object, the one or more surfaces being on the inside or the outside of the virtual object; and
determine that any point on the identified one or more surfaces is one of the teleportable points.

18. The non-transitory computer-readable medium of claim 16, wherein the instructions further cause the one or more processors to:
identify one or more specified points on the virtual object; and
determine that the one or more specified points are the teleportable points.

19. The non-transitory computer-readable medium of claim 16, wherein the instructions further cause the one or more processors to:
identifying one or more specified components of the virtual object; and
determining that any point on the specified components is one of the teleportable points.

20. The non-transitory computer-readable medium of claim 16, wherein the instructions further cause the one or more processors to:
determine whether a directional beam of a virtual tool or a direction of a gaze of the user intersects with the virtual object at a point of intersection;
after determine that the directional beam or the direction of the gaze does not intersect with the virtual object, determining that there is no user intent to relocate the virtual position of the user to a teleportable point of the virtual object;
after determining that the directional beam or the direction of the gaze intersects with the virtual object, determine whether a user command to teleport is received;
after determining that no user command to teleport is received, determine that there is no user intent to relocate the virtual position of the user to a teleportable point of the virtual object;
after determining that the user command to teleport is received, determine whether the point of intersection is one of the teleportable points; and
after determining that the point of intersection is one of the teleportable points, determine that there is user intent to relocate the virtual position of the user to the first teleportable point of the virtual object at the point of intersection.
